(19) United States
(12) Patent Application Publication
(10) Pub. No.: US 2018/0217791 A1
(43) Pub. Date: Aug. 2, 2018

(54) PRINTING LABELS

(71) Applicant: HP INDIGO B.V., Amstelveen (NL)

(72) Inventor: Gideon Amir, Nes Ziona (IL)

(21) Appl. No.: 15/748,579

(22) PCT Filed: Oct. 29, 2015
(86) PCT No.: PCT/EP2015/075178

§ 371 Date: Jan. 29, 2018

(51) Int. Cl. G06F 3/12; G09F 3/00; G09F 3/10; B41J 3/407

(52) U.S. Cl. CPC G06F 3/1208; B41J 3/4075; G09F 3/10; G09F 3/0288

(57) ABSTRACT

In some examples, data comprising a design and addressing information is received, the addressing information comprising an approval address and a target address. A print instruction may be created from the data. The print instruction comprise an instruction to print at least one label bearing the design, a first address label comprising the approval address and a second address label comprising the target address. The design may be printed, wherein at least one label bearing the design is to be attached to product packaging. The first and second address labels may also be printed, wherein the address labels are to be attached to a postal object.

### BACKGROUND

In dissemination of information, for example for the promotion of products and services, it may be intended to provide information to a selected target audience. Well targeted information, such as advertising, is likely to more effectively convey a message. In some examples, printed information is intended for long term use, being embodied in an article which has value to a target recipient of the information, such as a pen, or a mouse mat, or the like. Such an article is less likely to be immediately discarded, compared for example a newspaper or flyer and therefore a recipient may be repeatedly exposed to its content, and the information may be seen by multiple recipients over time.

### BRIEF DESCRIPTION OF DRAWINGS

Examples will now be described, by way of non-limiting example, with reference to the accompanying drawings, in which:

FIG. 1 is a flowchart of an example method of printing labels;

FIG. 2 is a flowchart of an example method of printing and distributing labels;

FIG. 3 a simplified schematic of an example strip of labels;

FIG. 4 is a flowchart of an example method of printing and distributing labels, and receiving reporting data;

FIG. 5 is a simplified schematic of an example processing apparatus for printing labels; and

FIG. 6 is a simplified schematic of an example processor associated with a computer readable medium.

### DETAILED DESCRIPTION

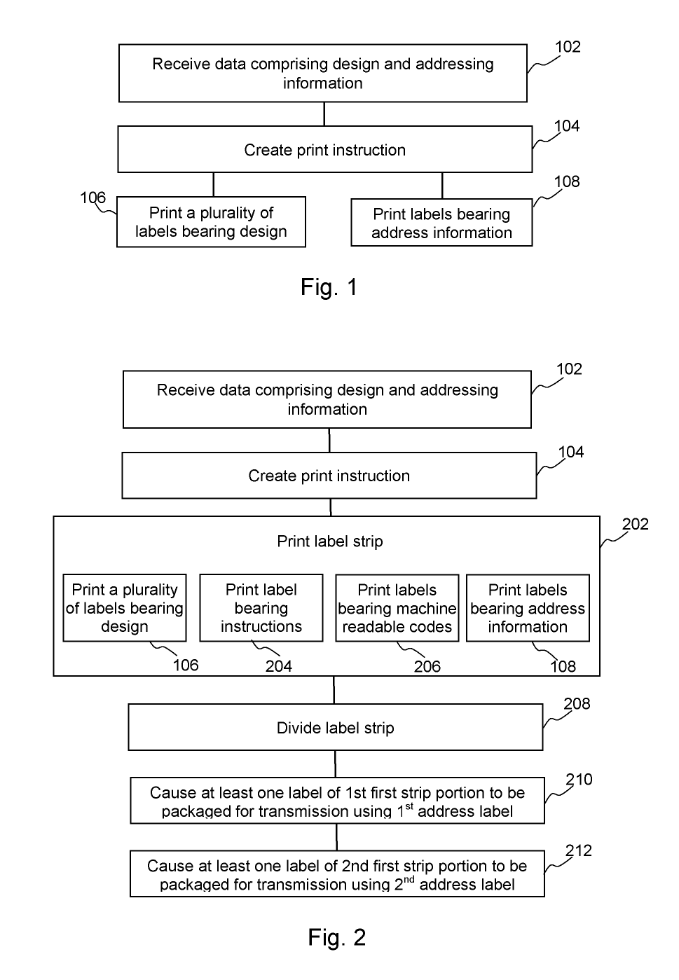

FIG. 1 is a flow chart of an example of a method for printing designs, which may be advertising designs. In this example, the method comprises in block 102 receiving data comprising a design and addressing information, the addressing information comprising an approval address and a target address. The approval address may be a contact address of a person or entity entitled to approve a design. The target address may be the contact address of a person or entity intended to use the printed design, for example a product retailer.

In block 104, a print instruction is created from the data. In this example, the print instruction comprises an instruction to print a plurality of labels bearing the design, a first address label comprising the approval address and a second address label comprising the target address. In some examples, a print instruction may specify a size and/or the dimensions of the design to be printed on a label, and/or may specify customisations to the label design, such as customisation of the color, content, shape or the like. In some examples, there may be one or a few different display region/label sizes, which may for example be associated with different products, or with different sized packages of the same product. The print instructions may specify one or more of these sizes. In some examples, a feature such as a border may be determined to match the packaging of a particular product, for example such that the design appears to be part of the initial sales packaging design graphics, and the print instruction may include an instruction to print such a border. As the print instruction may in some examples be determined after a product to which it is to be applied has been identified, aspects (e.g. color, content, shape, size or the like) of the design, or for a label bearing a design, may be tailored to the product and specified in the print instruction.

In block 106, a plurality of labels bearing the design are printed according to the print instruction, wherein the printed design is to be attached to product packaging. For example, the labels may comprise adhesive labels, for example labels having a self-adhesive backing. In some examples, the labels bearing the printed design may have a predetermined size or shape, for example to match the size or shape or a display region on a product packaging. By providing labels which match an intended display region in size, the label may be incorporated into packaging without obscuring other design features or information provided by the packaging. In some examples, the size of a label may be associated with a cost level.

In block 108, the first and second address labels are printed. The address labels are to be attached to a postal object. The address labels may comprise adhesive labels, for example labels having a self-adhesive backing. In some examples, the address labels are similar in design to the labels bearing the printed design, for example comprising the same attachment means, and/or having at least one substantially similar dimension (for example, having the same height and/or width). This may facilitate printing multiple labels having different content (e.g. addresses, designs or other content).

In the method of FIG. 1, the address labels may be used to distribute the labels bearing the printed design. For example, a first ‘proofing’ design may be sent to a person or entity entitled to approve the design using the first address label. The first address label may for example be attached to an envelope containing at least one design, or to a card to which a label bearing the design has also been attached. A plurality of labels bearing the design may be sent in an envelope or packaging bearing the second address label, and thereby be received by an entity which is to use the labels bearing the designs, for example by applying them to product packaging. A print instruction may result in a plurality of labels having different content (or different categories of content, such as address content, design content and the like) being printed in a single print run.

In some examples, the labels may be relatively thin and flexible such that they will follow the form of product packaging, for example comprising paper, plastic or cardboard. In some examples, the labels may comprise a protective coating to preserve the design content thereon. The labels may comprise a self-adhesive backing, or a gum which becomes adhesive on contact with moisture, or they may be intended to have an adhesive applied thereto. In some examples, the labels may be magnetic. Applying the designs to product packaging, which may comprise sales packaging (i.e. the packaging presented to the consumer at the point of purchase) may mean that the consumer has repeated exposure to the design. It may be the case that a product is used over time from its sales packaging (for example, beverages or cereals may be poured from their packaging). In addition, the design may add to the appeal of the product, for example if design is attractive, interesting or for example comprises a coupon or offer entitling a consumer to a discount. Further, as the design may be applied by the retailer, rather than being applied by the product distributor, it may be the case that different products bear labels having different designs. In that case, the consumer may themselves select the design they will be repeatedly exposed to, thus providing a communication which is to some extent invited by a user, possibly indicating a predisposition towards a design or a message communicated by the design. Designs may comprise public announcements (which may be localized) and community service information.

Furthermore, the production of labels may be carried out relatively quickly, unlike the distribution of some products (for example, food products, refrigerated products or fragile products) which is relatively complex, often requiring specialised transportation, storage and tracking. Therefore, separating the distribution of labels from the distribution of the product may allow for more responsive content adaptability of packages. This may for example allow content to be distributed which corresponds to current or imminently expected events, or closely tracks market conditions or the like. In contrast, changing pre-printed sales packaging may be a relatively long process, taking time to reach the market place.

FIG. 2 is another example of a method, and comprises the blocks set out in FIG. 1. In this example, block 104 comprises, in creating a print instruction creating an instruction to print a first grouped plurality of labels and a second grouped plurality of labels.

In this example, the print instruction comprises an instruction to print, in block 202, a strip of labels. In printing the strip, in addition to printing labels bearing the design in block 106 and printing labels bearing addresses in block 108, label application instructions are printed (block 204). The label application instructions so printed may explain the application of the labels bearing the design to product packaging. For example, the label application instructions may direct the recipient as to how or where to attach the labels, or to which product or products the labels are to be applied.

The print instruction further comprises an instruction to print, in block 206 machine readable codes, the machine readable codes providing access to an interface for a reporting portal to report at least one handling of the printed designs. The machine readable codes may for example comprise bar codes, Quick Response (QR) codes or the like. A “handling” may comprise, for example, completion of printing, completion of quality assessment, transmission of the printed designs, receipt of the printed designs, attachment of at least one printed design to a product packaging, or the like. In one example, a recipient of labels bearing the design may scan a tag to indicate the designs have been received, and scan another tag to provide an indication that at least one label has been applied to a product package. For example, a tag may be scanned to indicate when all the labels bearing the design supplied with the tags have been applied to packages. This may prompt another action, such as the transmission of more labels, or the payment of fees, or the like.

In another example, at least one machine readable code may be for sending to the approval address. Such a code may be scanned to provide access to an interface to report approval of the design, for example either indicating automatic approval or inviting more detailed feedback, for example via text entry. In other examples, a predetermined time delay may be taken as tacit approval of a design.

In some examples, the first grouped plurality of labels may comprise the first address label, at least one label bearing the design, and may also comprise in some examples at least one machine readable code. The second grouped plurality of labels may comprise the second address label, a plurality of labels bearing the design and, and may also comprise in some examples at least one machine readable code and/or at least one label bearing instructions.

In the example of FIG. 2, a strip of labels is printed, wherein a plurality of said labels bear the design, at least one label comprises the first address, and at least one label comprises the second address. In this example the labels further comprise machine readable codes. The strip of labels may for example be adhesive labels arranged on a low adhesion release backing.

In block 208, the strip is divided. A first strip portion comprises at least one label for sending to the first address (and may comprise the first grouped plurality of labels) and second strip portion comprises at least one label for sending to the second address (and may comprise the second grouped plurality of labels). The first strip portion may comprise fewer labels bearing the design than the second strip portion. Either or both of the first and second strip portions may comprise a machine readable code. The machine readable codes may also be printed as labels, for example for simplicity of operation. The strip portions may be formed continuously, i.e. the print instruction may comprise an instruction to print a first continuous row of labels for inclusion on the first strip portion and a second continuous row of labels for inclusion on the second strip portion. In some examples, this may comprise an instruction to print the labels of one of the first and second strip portion, and then print the labels of the other of the first and second strip portion. In some examples, there may be a frangible portion formed between the first and second strip potions such that they can be readily divided. This may for example take the form of a perforated region. In some examples, there may be a spacing between the first and second strip portions such that division thereof need not be precise. In some examples, the spacing may be provided by at least one unprinted label. Instructions for providing such a spacing and/or frangible portion or the like may be provided within the print instruction.

In block 210, the method comprises causing at least one label of the first strip portion to be packaged for transmission using the first address label (in an example, this may be a single label bearing the design) and, in block 212, causing at least one label of the second strip portion to be packaged using the second address label (in an example, this may comprise a plurality of labels bearing the design). In some examples, causing the labels to be packaged for transmission may comprise issuing a control signal, or an instruction to be executed manually, or the like. In some examples, the first strip portion may initially comprise a label bearing the first address, and the second strip portion may initially comprise a label bearing the second address. The address labels may be removed from a strip portion and applied to a postal object, e.g. a post card, envelope or postal packaging to address those objects.

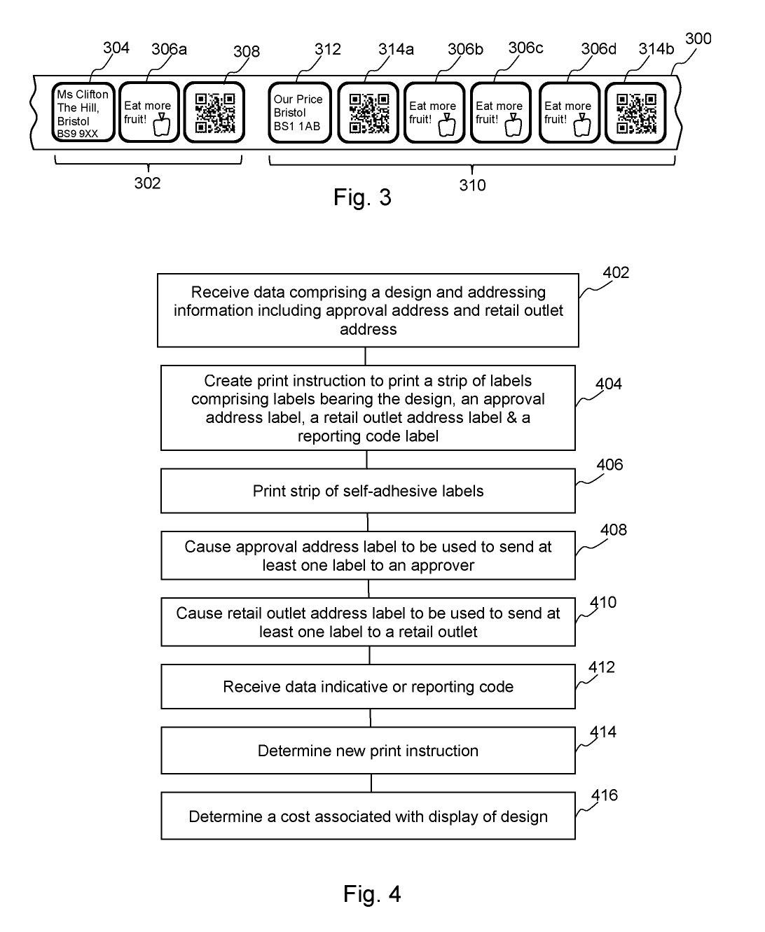

An example of a strip of labels 300 is shown in FIG. 3. In this example, a first strip portion 302 comprises a first grouped plurality of labels, comprising a first address label 304 addressed to an intended approver of the design, a first label bearing the design 306a, which is intended to be sent to the approver, and a machine readable tag label 308. The approver can indicate approval of the design by scanning the tag, for example using an image capture device connected to the internet (for example a mobile telephone having a camera). In some examples, scanning the tag indicates approval. In other examples, scanning the tag may result in access to an interface or portal allowing an approver to indicate their approval or otherwise of the design. In some examples the first address label 304 may be used to address a package, envelope or a postcard bearing or containing the first label bearing the design 306a and the machine readable tag label 308.

A second strip portion 310 comprises a second grouped plurality of labels, comprising a second address label 312 addressed to an intended user, or applier, of the labels bearing the design. This may for example be the address of a retail outlet. A plurality of labels 306b-d bearing the design are also provided, as are two machine readable tag labels 314a, 314b. In this example, a first tag label 314a of the second strip portion 310 is intended to be scanned to indicate receipt of the strip portion and a second tag label 314b is intended to be scanned to indicate that all the labels bearing the design 306b-d have been applied to product packaging. The second strip portion 310 may be separated from the first strip portion 302 and sent to the intended user at the target address using the second address label.

In this example, the labels 302, 304, 306, 308, 312, 314 comprise the same dimensions. This simplifies production and a strip of blank print labels may be freely printed with any type of label. Indeed, by providing labels in a strip, waste and/or complexity may be reduced as the labels in a strip may be fully utilised while freely specifying the number of labels to be printed (when compared to, for example, a sheet of labels, which will be fully utilised when the number of labels specified is the same as the number of labels on the sheet, but labels will otherwise be wasted). In other examples, the labels may have different dimensions.

By printing the labels as a strip in this manner, in particular if two strip portions bearing labels which are intended for a particular one of the addresses are printed, the logistical burden in distributing the labels is reduced. Providing machine readable reporting tags 308, 314 also minimises the burden on a recipient to report interactions with the labels. Moreover, as the labels may be printed based on a single shared print instruction in some examples, and may be based on a combined data input, the labels are effectively pre-sorted from the point of production. Further, in some examples, an approver may approve labels printed in the same print run as the labels which are to be applied to a product, allowing appropriate assessment of the print quality of that print run. The groupings of grouped labels may reflect the intended recipient of the labels, such that a first grouped plurality of labels has a first intended recipient and a second grouped plurality of labels has a second intended recipient.

FIG. 4 is an example of a method comprising, in block 402, receiving data comprising a design and addressing information, the addressing information comprising an approval address and a retail outlet address. In block 404, a print instruction is created from the data, the print instruction comprising an instruction to print a strip of labels, the strip of labels comprising a plurality of labels bearing the design, at least one label bearing the approval address, at least one label bearing the retail outlet address, and at least one label comprising a reporting code. In block 406, a strip of labels is printed according to the print instruction, wherein the labels are adhesive labels. In block 408, the method comprises causing the label bearing the approval address to be used to send at least one label bearing the design to an approver and, in block 410, causing the label bearing the retail address to be used to send at least one label bearing the design to a retail outlet. This may comprise outputting an instruction to be executed manually, or controlling provision of the labels to a person who may carry out addressing and distribution of the labels, or the like.

In block 412, data indicative of at least one reporting code is received. This may for example be a scan of a machine readable tag as described above, or a manually entered code or the like. In block 414, and in response to receiving the data, a new print instruction is determined. In this example, this comprises a print instruction to print more labels of the same or different design to send to the target address. In block 416, and in response to receiving the data, a cost associated with displaying the design is determined. This may for example be a determination of a fee to be paid to the retail outlet for advertising by applying the labels to products, or an invoice to be sent to the person or entity requesting advertisement by use of the labels.

FIG. 5 is an example of processing apparatus 500 comprising an interface 502, a print instruction module 504 and a reporting module 506.

The interface 502 is to receive data 508 indicative of a design and data 510 indicative of a retail outlet address. The print instruction module 504 is to receive data from the interface and to determine from said data a print instruction 512 to print a plurality of labels bearing the design, at least one label bearing the retail outlet address; and at least one label bearing a machine readable reporting tag. In some examples, the print instruction module 504 may be to determine a print instruction to print at least one label bearing a machine readable tag for use in indicating receipt of the labels bearing the design by the retail outlet and/or at least one label bearing a machine readable tag for use in indicating that at least one of the labels bearing the design has been applied to sales packaging of a product by the retail outlet.

The reporting module 506 is to receive data 514 indicative that the machine readable reporting tag has been read, and to report at least one of receipt of labels bearing the design by a retail outlet, or use of labels bearing the design by the retail outlet in a report 516. The report 516 may for example be for tracking or invoicing purposes. By transmitting a reporting code on a label with the labels, the code may be readily to hand when an interaction with the label is due to be reported.

In some examples, the interface 502 receives data indicative of an approver address, and the print instruction module 504 is to determine a print instruction to print at least one label bearing the approver address, and at least one machine readable reporting tag for use by the approver in approving a label bearing the design, and the reporting module 506 is to receive data indicative that the machine readable reporting tag for use by the approver in approving a label bearing the design has been read.

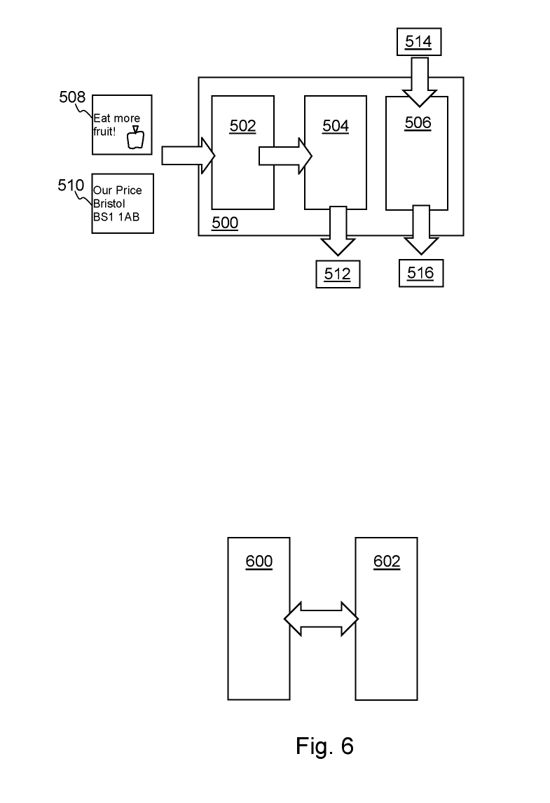

FIG. 6 is an example of a processor 600 in communication with a computer readable medium, in this example a memory 602. In some examples, the memory may comprise machine readable instructions which, when executed by the processor 600, cause the processor 600 to carry out any, or any portion of, the methods set out herein. In some examples, the processor 600 may comprise processing apparatus 500 as described in relation to FIG. 5. The memory 602 may store data, such as addressing data, design data, machine readable tags data, reporting code data or the like. The memory 602 may store an association between a reporting code, addressing data and design data, for example in a look up table, database or the like. In some examples, the memory 602 may comprise instructions which, when executed by the processor 600, generate machine readable tags.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus such as the processing apparatus 500 or the processor 600 may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with those of another example

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
receiving data comprising a design and addressing information, the addressing information comprising an approval address and a target address;
creating a print instruction from the data, the print instruction comprising an instruction to print at least two labels bearing the design, a first address label comprising the approval address and a second address label comprising the target address;
printing the labels bearing the design according to the print instruction, wherein at least one label bearing the design is to be attached to product packaging; and
printing the first and second address labels according to the print instruction, wherein the address labels are to be attached to a postal object.

2. The method according to claim 1 in which the print instruction comprises an instruction to print a first grouped plurality of labels comprising the first address label and at least one label bearing the design, and a second grouped plurality of labels comprising the second address label and a plurality of labels bearing the design.

3. The method according to claim 2 in which the print instruction comprises an instruction to print:
as part of the first grouped plurality of labels, a machine readable code label, the code printed thereon being to provide access to an interface to report approval of the design; and
as part of the second grouped plurality of labels, at least one machine readable code label, the code printed thereon being to provide access to an interface to report at least one of: receipt of the printed designs, attachment of at least one label bearing the design to a product packaging.

4. The method according to claim 1 in which printing comprises printing a strip of labels, wherein a plurality of said labels bear the design, at least one label comprises the first address label, and at least one label comprises the second address label.

5. The method according to claim 4 further comprising dividing the strip into a first strip portion comprising labels for sending to the first address and second strip portion comprising labels for sending to the second address.

6. The method according to claim 1 further comprising causing a first number of labels bearing the design to be packaged using the first address label and causing a second, different number of labels bearing the design to be packaged using the second address label.

7. The method according to claim 1 in which the print instruction comprises an instruction to print label application instructions, the label application instructions being for sending to the target address.

8. The method according to claim 1 in which the print instruction comprises an instruction to print machine readable codes, the machine readable codes providing access to an interface to a reporting portal to report at least one handling of printed labels.

9. The method according to claim 8 in which the machine readable code comprise at least one of:
(i) a code for sending to the target address, the code being to provide access to an interface to report at least one of: receipt of the printed designs, attachment of at least one printed design to a product packaging; and
(ii) a code for sending to the approval address, the code being to provide access to an interface to report approval of the design.

10. A method comprising
receiving data comprising a design and addressing information, the addressing information comprising an approval address and a retail outlet address;
creating a print instruction from the data, the print instruction comprising an instruction to print a strip of labels, the strip of labels comprising a plurality of labels bearing the design, at least one label bearing the approval address and at least one label bearing the retail outlet address;
printing the strip of labels according to the print instruction, wherein the labels are adhesive labels,
causing the label bearing the approval address to be used to send at least one label bearing the design to an approver;
causing the label bearing the target address to be used to send at least one label bearing the design to a retail outlet.

11. The method according to claim 10 wherein the print instruction further comprises an instruction to print at least one label comprising a reporting code, wherein the reporting code is for use in reporting at least one process in relation to use of the design

12. The method according to claim 11 comprising receiving data indicative of at least one reporting code, and in response to receiving the data, performing at least one of: determining a new print instruction, determining a cost associated with display of the design.

13. Processing apparatus comprising:
an interface to receive data indicative of a design and data indicative of a retail outlet address;
a print instruction module, to determine receive data from the interface and to determine from said data a print instruction to print a plurality of labels bearing the design, at least one label bearing the retail outlet address; and at least one label bearing a machine readable reporting tag; and
a reporting module, to receive data indicative that the machine readable reporting tag has been read, and to report at least one of: receipt of the labels bearing the design by a retail outlet; use of the labels bearing the design by the retail outlet.

14. The processing apparatus according to claim 13 in which the print instruction module is to determine a print instruction to print at least one label bearing a machine readable tag for use in indicating receipt of the labels bearing the design by the retail outlet; and at least one label bearing a machine readable tag for use in indicating that at least one of the labels bearing the design has been applied to sales packaging of a product by the retail outlet.

15. The processing apparatus according to claim 13 in which the interface is to receive data indicative of an approver address, and the print instruction module is to determine a print instruction to print at least one label bearing the approver address, and at least one machine readable reporting tag for use by the approver in approving a label bearing the design, and the reporting module is to receive data indicative that the machine readable reporting tag for use by the approver in approving a label bearing the design has been read.
